(19) United States
(12) Patent Application Publication
(10) Pub. No.: US 2009/0276301 A1
(43) Pub. Date: Nov. 5, 2009

(54) System and Method for Identifying Ideas

(75) Inventors: John Andrew Harvey, New York, NY (US); Geraint Neil Preston, New York, NY (US); Hood Qa'lm-Maqami, Montclair, NJ (US)

Correspondence Address: MORGAN, LEWIS & BOCKIUS LLP, 1701 MARKET STREET, PHILADELPHIA, PA, 19103-2921, US

(73) Assignee: Barclays Capital Inc., New York, NY (US)

(21) Appl. No.: 12/433,303

(22) Filed: Apr. 30, 2009

Related U.S. Application Data
(60) Provisional application No. 61/126,111, filed on Apr. 30, 2008.

(51) Int. Cl. G06Q 10/00; G06Q 30/00

(52) U.S. Cl. 705/14.2

(57) ABSTRACT

A system and method for associating value with ideas. Unit of value indicators are issued to users. Ideas are identified by the users and submitted to the system. The users make requests to associate the unit of value indicators with the submitted ideas. As a result of an award event, an award winner is issued additional unit of value indicators. The award winner further associates such unit of value indicators with the ideas.

### CROSS REFERENCE TO RELATED APPLICATIONS

This application claims the benefit of the U.S. Provisional Patent Application No. 61/126,111 fled on Apr. 30, 2008, which is hereby incorporated by reference.

### FIELD OF THE INVENTION

The present invention relates to a system and method for associating value with ideas and identifying ideas for implementation.

### SUMMARY OF THE INVENTION

The present invention is directed to a system and method for associating value with ideas. Unit of value indicators are issued to users. Ideas are identified by the users and submitted to the system. The users make requests to associate the unit of value indicators with the submitted ideas. As a result of an award event, an award winner is issued additional unit of value indicators. The award winner further associates such additional unit of value indicators with the ideas.

It is to be understood that both the foregoing general description and the following detailed description and drawings are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a screen shot of an exemplary user interface that may be used in connection with an embodiment of the invention;

FIG. 2 is a screen shot of an exemplary user interface that may be used in connection with an embodiment of the invention;

FIGS. 3A and 3B are screen shots of an exemplary user interface that may be used in connection with an embodiment of the invention;

FIG. 3C is a screen shot of an exemplary user interface that may be used in connection with an embodiment of the invention;

FIG. 4 is a schematic diagram of an exemplary system that may be used in connection with an embodiment of the invention;

FIG. 5 is an exemplary database schema of database 402 of FIG. 4; and

FIG. 6 is flow chart illustrating the steps of an exemplary method carried out in connection with an embodiment of the present invention.

### DETAILED DESCRIPTION

Reference will now be made in detail to the embodiments of the present invention, examples of which are illustrated in the accompanying drawings.

Described herein is a system and method for establishing a venue that allows participants to generate ideas and assign value to those ideas, which may ultimately assist in determining which of the ideas generated through the forum should be implemented in the organization.

In the exemplary embodiment described herein, an on-line marketplace is established where individuals can come together to register and securitize ideas; invest units of value in each idea; discuss the merits of those ideas and help refine and expand those ideas; and recognize and reward peers. While the embodiment described herein involves a virtual marketplace, where ideas are securitized and shares of the ideas are bought and sold in the on-line exchange, the invention is applicable to any type of venue or forum in which ideas are generated and participants in the forum assign value to the ideas.

In the described embodiment, for purposes of illustration, the ideas that are the subject of the marketplace are those of employees within an organization and relate to information technology (IT). However, as will be understood to one skilled in the art, the present invention is not limited to this subject matter and may encompass ideas proffered by any group of individuals, on any topic.

Participants are allocated unit of value indicators. In the exemplary embodiment described herein, the unit of value indicators are currency; however, any indicator of value can be used within the scope of the present invention (points or votes, by way of example). Employees are allocated an initial capital amount of currency (for example $10,000) and/or a certain number of tokens (e.g., 10 tokens) that can be used in different ways. For example, the dollars can be used to invest in ideas or as idea bounties, described in more detail below. Tokens can be distributed as peer rewards that can, ultimately, be redeemed for dollars by the recipient, or dollars can be directly distributed. In some embodiments, tickets can be purchased with tokens. The system thus provides the optional flexibility to convert tickets into tokens using, e.g., ratios. In some embodiments, tickets may be turned into tangible rewards or into dollars which can be used to play the ideas market. Thus, participants are able to choose to obtain an instant reward or to support an idea.

In connection with the award component of the inventive system and method, some employees will have more influence on assigning value to ideas (e.g., in the exemplary embodiment, more capital to invest in ideas through the marketplace). In particular, certain employees will have assigned to them more unit of value indicators because, e.g., such employees are perceived as exemplary by their peers and will have unit of value indicators awarded to them; such employees assign unit of value indicators to ideas that are ultimately considered for implementation or actually implemented; such employees generate ideas that are ultimately considered for implementation or actually implemented within the organization; and/or such employees respond to questions in the forum thereby gaining additional unit of value indicators. Other ways in which such employees gain additional unit of value indicators are within the scope of the present invention. Thus, the market is intentionally seeded by using recognition, including peer recognition, as a weighting mechanism under the assumption that certain individuals are high performers and, as such, their opinion should have more value. The playing field is thus intentionally uneven, eschewed towards employees that are perceived as exceptional by their peers; are more helpful in that they respond to questions in forums; have good answers to questions raised in forums; generate valuable ideas; and/or invest in valuable ideas, by way of example. In this scenario, value is not derived from employees' titles or compensation, but based on their behavior and how they are perceived by their peers, thereby reinforcing the concept of a meritocracy. The likelihood of identification of good ideas is increased by the availability of investable value to those employees recognized by the community as having the highest value in the organization (not simply in terms of positional authority).

Exemplary embodiments will now be described in more detail, with reference to an online marketplace by way of example.

In this example, a virtual stock market is provided where individuals (e.g., IT employees) can float their ideas, test their concepts with investors, or invest in ideas submitted by colleagues. If a submitted idea does well with investors, a review committee can recommend that it be considered for implementation and/or ultimately implemented within the organization. These ideas can range from specific project opportunities to new applications to cost-saving ideas, by way of example. In some exemplary embodiments, a finite period of time is established for an idea to remain in the market (e.g., 4 weeks). After that period of time, ideas that have achieved a given value are deemed worthy for consideration for implementation and/or ultimately implemented. In other exemplary embodiments, unit value indicators (e.g., dividends) are paid to investors in ideas which, at the end of the idea's time in the market were, in increasing dividend value: (1) high value ideas, (2) considered worthy of implementation, or (3) actually implemented. In this embodiment, the inventor of the idea would receive proportionally extra dividends.

As with an initial public offering, idea trading begins when employees securitize their ideas. Employees within the organization start with an initial capital, e.g., $10,000 dollars, which can be used to buy and/or sell securitized ideas through the system. Underlying the online marketplace there is a prediction markets algorithm that mirrors how the stock market works, in an exemplary embodiment, as follows. Employees register ideas as stocks through the marketplace. Every employee has an initial amount of capital to invest in ideas. Depending on how many employees invest in an idea and how they view that idea, prices can go up or down. An idea goes up in value as employees recognize its potential by investing their dollars in it. An idea can go down in value when employees sell an idea short, as they think its value will go down in the long run, or when other ideas go up in value as there is a limited pool of ideas.

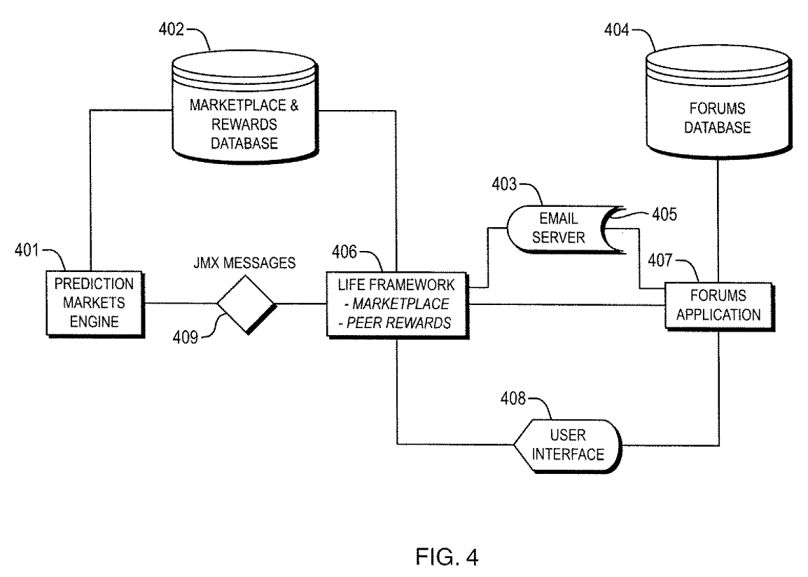

In one embodiment, a prediction markets engine (by way of example, prediction markets engine 401 of FIG. 4 described herein) executes a program that uses a beta value to determine the volatility of the market. For example, as users purchase positions in a stock, the value will increase on an exponential function. The value of the stock will start to increase slowly but, as it increases, so will its growth. Thus, as more and more users purchase the stock, its price will increase exponentially. This will continue until it reaches a cap, in one embodiment. The cap will prevent the price of the stock to reach past a certain value, e.g., $200. The algorithm used by the engine can be expressed as follows:

/** what would the probability be after buying QUANT coupons? */
private double probAfterBuyingQuantity(Position position, double quantity)
{

return currentProbability(position) * Math.exp(quantity / beta( ));

}
/** The money price charged to move the probability from p to newP is B * log((1 − newP)/(1 −
p) */
double currencyDecrement(Position position, double targetProbability)
{

return beta( ) * Math.abs(Math.log((1.0 − targetProbability) / (1.0 −

currentProbability(position))));
}

In addition to and complementing the Idea Trading marketplace, individuals (e.g., IT employees) are encouraged to participate in Forums. Forums are virtual spaces that not only enhance the productivity of distributed teams, but that encourage collaboration and the exchange of ideas while enabling peer recognition.

In the online forums, employees can start a new thread and mark it as a question. In order to encourage employees to answer this question, they can post an idea bounty. Tokens or dollars can be used as bounties. As an example, if an employee has a question, he or she can pose that question in the forms soliciting answers. The employee may post a bounty for the idea and award a number of tokens to the colleague that provides an acceptable answer. They also have the option to link the thread to Idea Trading by designating the thread as a securitized idea in which employees can trade.

Just like in Idea Trading, employees are initially awarded a number of tokens they can use to reward their peers based on merit. Forums provide every IT employee an opportunity to recognize the exceptional work of colleagues. This tool allows employees to distribute tokens to co-workers who exemplify the company's core values. These initial tokens are distributable and only have monetary value once they have been distributed. Cashing tokens gives additional dollars to employees that can be used to trade in the ideas marketplace. Thus, as with tokens awarded to employees, employees that are helpful and provide answers to questions posted in the forum obtain additional currency that is then reinvested in the market.

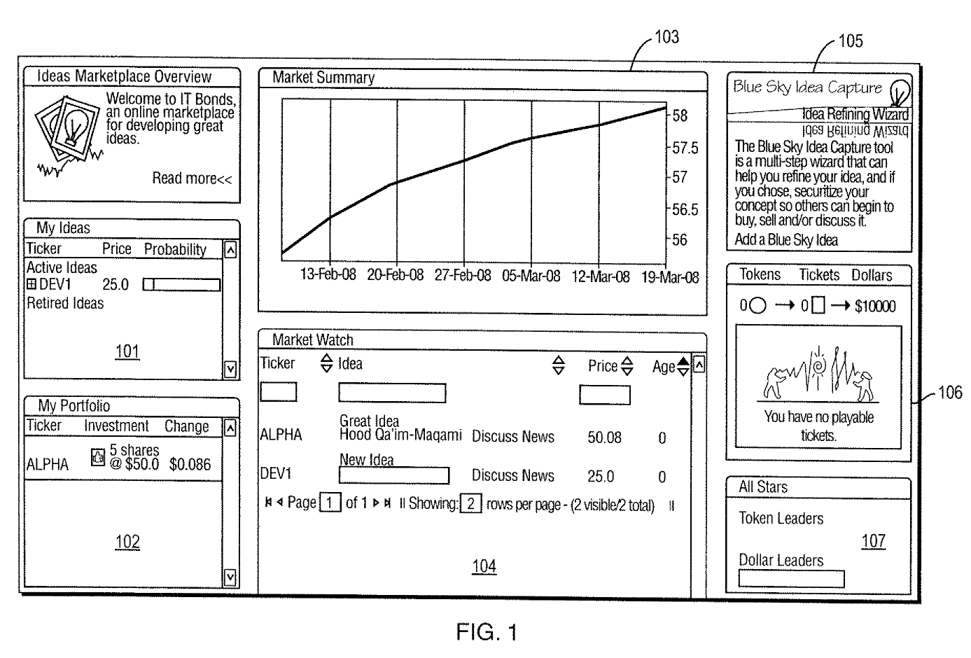

FIG. 1 is an exemplary interface for the ideas marketplace. My ideas section 101 displays the individual's ideas and the current number of outstanding shares of the idea. My Portfolio section 102 displays the stocks that the individual currently owns and any changes to the price per share after its initial issuance. Market summary section 103 displays an index level for the marketplace. Market watch section 104 displays information about selected ideas the individual wants to track. Idea capture section 105 is an application that helps the employee scrutinize and refine his idea to get it ready for trading in the marketplace. Bank account area 106 displays information about how many tokens, tickets and dollars the individual has. In some embodiments, the user is able to convert the peer rewards that they receive into a scratch off ticket to earn more dollars to invest. All stars display area 107 identifies token and dollar leaders in the market.

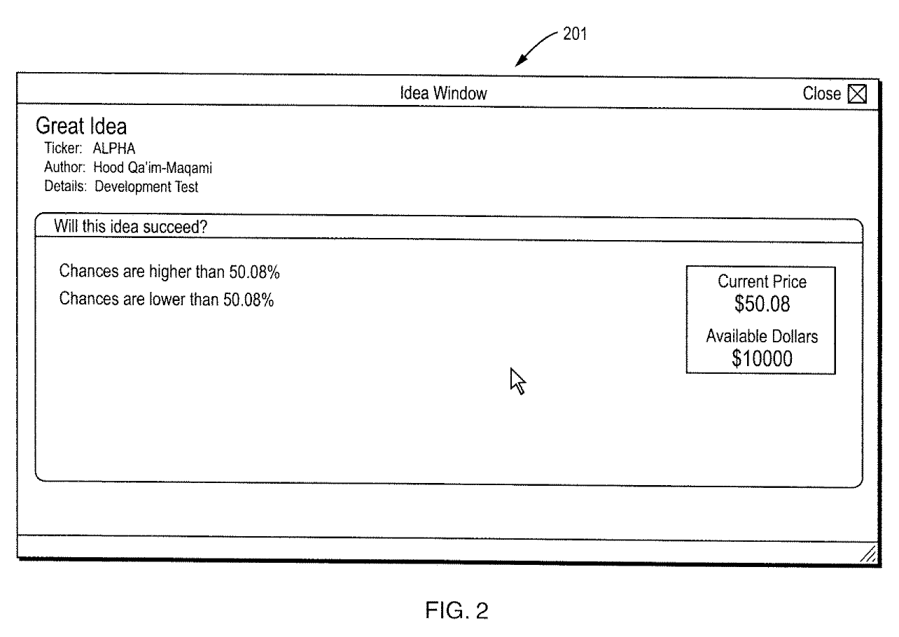

FIG. 2 is an exemplary purchase screen 201. It displays the title, description, and the current price of the idea. When the individual chooses to buy or sell shares of an idea, this screen also displays the adjusted price based on the number of shares in the transaction.

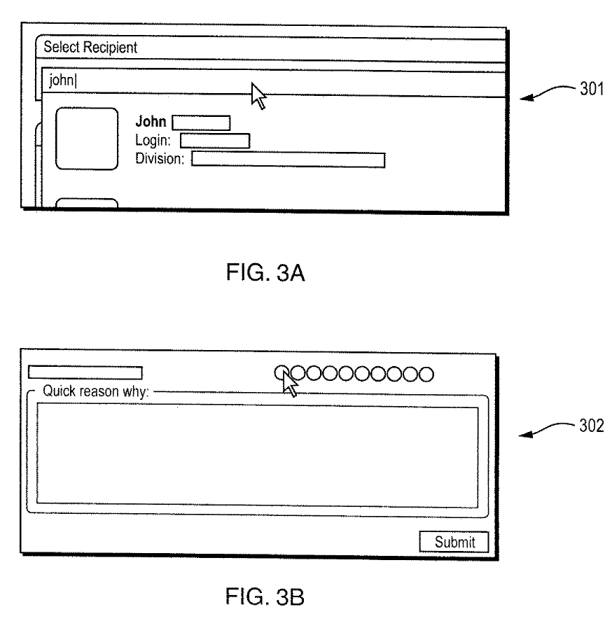

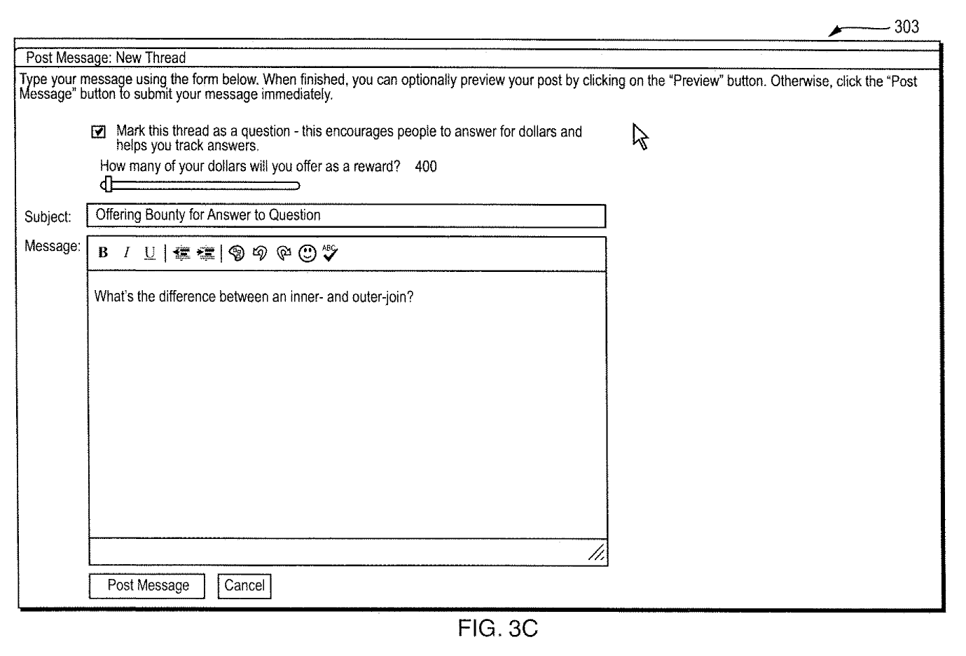

With reference to FIGS. 3A and 3B, an individual can search for a fellow employee using screen 301 and, once the fellow employee is selected, the individual can select how many tokens to award to this person, using screen 302. In some embodiments, the individual is given the opportunity to insert a message explaining why he is giving the reward.

FIG. 3C depicts an exemplary screen 303 that allows for creation of bounties in forums. In this example, a $400 bounty is offered to anyone who can answer the question posed.

FIG. 4 is an exemplary system architecture that may be used to carry out the present invention. Prediction markets engine 401, described herein, determines the volatility of the market. Marketplace and rewards database 402 stores data relating to, by way of example, the total amount of currency each user has available to invest, the numbers of shares each user has in a given idea, and the current value of those shares, and the rewards awarded to a user. Framework 406 is the application that is responsible for updating idea prices in the marketplace and employee point totals in the rewards systems. JMX messages 409 provides a mechanism for standardizing communications between the applications. Electronic mail server 403 may be used to send and receive electronic mail related to the marketplace. For example, if a token is distributed to a user, the recipient may receive an email informing him of the same and inviting him to participate in the marketplace. Forum application 407 is the application that is responsible for maintaining forums in which ideas are generated, and tokens are generated for exemplary behavior, by way of example. User interface 408 (such as that illustrated by way of example in FIG. 1) is the application that allows users to interface with framework 406. Data relating to the same is maintained in forums database 404.

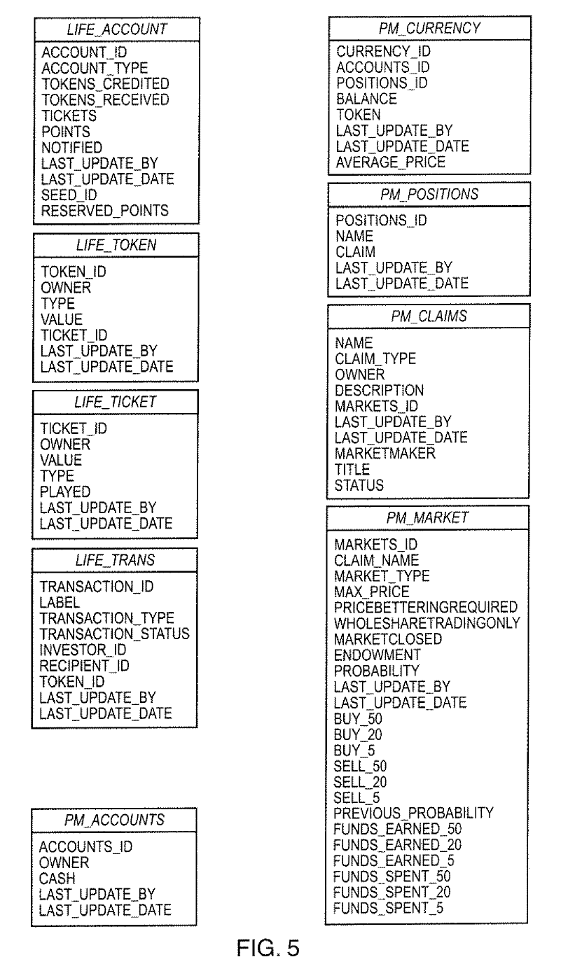

FIG. 5 is an exemplary schema for database 402 of FIG. 4.

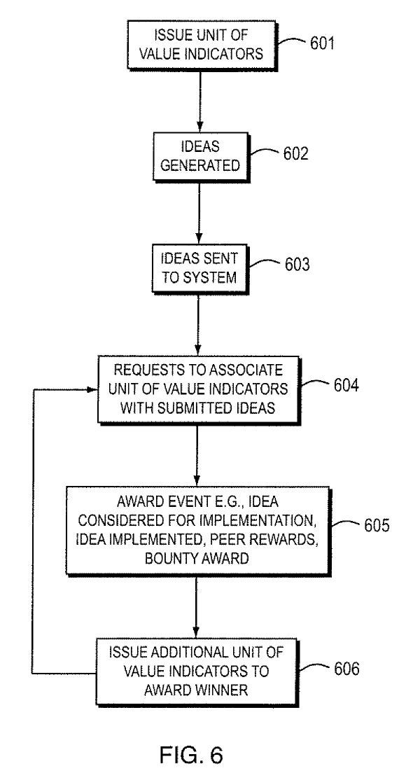

FIG. 6 is a flow chart illustrating steps for carrying out an exemplary method of the present invention. In step 601, unit of value indicators are issued to users of the system. In step 602, ideas are generated (e.g., through forums, with or without a bounty system) and sent to the system for processing in step 603. In step 604, the users make requests to associate the unit of value indicators with the submitted ideas. In step 605, an award event occurs. In step 606, certain of the users, i.e., an award winner, are issued additional unit of value indicators. The award winner then further associates such additional unit of value indicators with the ideas, as in step 604. The award event can be any type of event that results in a user receiving additional units of value indicators. For example, the award event can be a determination (e.g., made by a committee) to consider implementation an idea, or a determination actually to implement the idea. In this instance, the user who identified the idea and/or the users who associated unit of value indicators with the idea are awarded additional unit of value indicators. In some embodiments, the user who identified an idea that is chosen for implementation may be involved in the implementation itself, which may result in additional units of value indicators being awarded too the user. In another example, the award event may involve a user submitting a response to a question posted in a forum. In still another example, the award event may involve one user rewarding other user(s) with additional unit of value indicators (e.g., because such other user(s) completed a significant project, or otherwise made a significant contribution to the organization).

It will be apparent to those skilled in the art that various modifications and variations can be made in the system and method of the present invention without departing form the spirit or scope of the invention. Thus, it is intended that the present invention cover the modifications and variations of this invention provided they come within the scope of the appended claims and their equivalents.

What is claimed is:

1. A computer program product including a computer storage medium having stored thereon computer executable instructions that, when executed by a computer, direct the computer to perform a method comprising the steps of:
issuing to one or more users one or more unit of value indicators;
receiving from one or more of the one or more users an identification of one or more ideas;
receiving from one or more of the one or more users a request to associate one or more of the unit of value indicators with one or more of the one or more ideas; and
as a result of an award event, issuing to an award winner additional unit of value indicators that the award winner further associates with one or more of the one or more ideas.

2. The computer program product of claim 1 wherein the award event comprises one of: (i) a determination to consider implementation of one or more of the one or more ideas; and (ii) a determination to implement one or more of the one or more ideas.

3. The computer program product of claim 2 wherein the additional unit of value indicators are awarded to the one or more users that made the request to associate the unit of value indicators with the one or more ideas considered for implementation or the one or more ideas implemented.

4. The computer program product of claim 2 wherein the additional unit of value indicators are awarded to the user that identified the one or more ideas considered for implementation or implemented.

5. The computer program product of claim 1 wherein one or more of the one or more ideas are generated in a forum of users.

6. The computer program product of claim 5 wherein the award event comprises submission of a response by one or more of the one or more users to a question posed in the forum.

7. The computer program product of claim 1 wherein the award event comprises rewarding the additional unit of value indicators by one of the one or more users to another of the one or more users.

8. A system comprising:
one or more computer storage media that store data relating to one or more ideas identified by one or more users; one or more unit of value indicators issued to one or more users; and an association of one or more of the unit of value indicators with one or more of the one or more ideas as requested by one or more of the one or more users; and
an award engine configured to issue to an award winner, as a result of an award event, additional unit of value indicators that the award winner further associates with one or more of the one or more ideas.

9. The system of claim 8 wherein the award event comprises one of: (i) a determination to consider implementation of one or more of the one or more ideas; and (ii) a determination to implement one or more of the one or more ideas.

10. The system of claim 9 wherein the additional unit of value indicators are awarded to the one or more users that made the request to associate the unit of value indictors with the one or more ideas considered for implementation or the one or more ideas implemented.

11. The system of claim 9 wherein the additional unit of value indicators are awarded to the user that identified the one or more ideas considered for implementation or implemented.

12. The system of claim 8 wherein the one or more computer storage media further store data relating to ideas that are generated in a forum of users.

13. The system of claim 12 wherein the award event comprises submission of a response by one or more of the one or more users to a question posed in the forum.

14. The system of claim 8 wherein the award event comprises rewarding the additional unit of value indicators by one of the one or more users to another of the one or more users.

15. A method comprising the steps of:
issuing to one or more users one or more unit of value indicators;
receiving from one or more of the one or more users an identification of one or more ideas;
receiving from one or more of the one or more users a request to associate one or more of the unit of value indicators with one or more of the one or more ideas; and
as a result of an award event, issuing to an award winner additional unit of value indicators that the award winner further associates with one or more of the one or more ideas.

16. The method of claim 15 wherein the award event comprises one of: (i) a determination to consider implementation of one or more of the one or more ideas; and (ii) a determination to implement one or more of the one or more ideas.

17. The method of claim 16 wherein the additional unit of value indicators are awarded to the one or more users that made the request to associate the unit of value indicators with the one or more ideas considered for implementation or the one or more ideas implemented.

18. The method of claim 16 wherein the additional unit of value indicators are awarded to the user that identified the one or more ideas considered for implementation or implemented.

19. The method of claim 15 wherein one or more of the one or more ideas are generated in a forum of users.

20. The method of claim 19 wherein the award event comprises submission of a response by one or more of the one or more users to a question posed in the forum.

21. The method of claim 15 wherein the award event comprises rewarding the additional unit of value indicators by one of the one or more users to another of the one or more users.
